(19) United States
(12) Patent Application Publication
(10) Pub. No.: US 2001/0047458 A1
(43) Pub. Date: Nov. 29, 2001

(54) Independent communication control apparatus and independent communication control method

(76) Inventor: Tsuyoshi Iizuka, Tokyo (JP)

Correspondence Address: BIRCH STEWART KOLASCH & BIRCH, PO BOX 747, FALLS CHURCH, VA, 22040-0747, US

(21) Appl. No.: 09/838,324

(22) Filed: Apr. 20, 2001

(30) Foreign Application Priority Data
May 23, 2000 (JP) 2000-151202

(51) Int. Cl. G06F 12/00

(52) U.S. Cl. 711/154; 711/167

(57) ABSTRACT

The present invention aims to eliminate reading operation of control information from a memory by a communication control apparatus, to reduce the time required for sending process and to improve the system performance. The communication control apparatus connected to a processor executing an operating system (OS) and applications, for sending data to an outside device, has a communication control information table for specifying send control information received from the OS. On receiving a send activation instruction from the processor, the communication control apparatus specifies an address of the memory based on the instruction and contents of the send control information table, reads the data from the memory, and starts to send the data to a receiver.

### BACKGROUND OF THE INVENTION

1. Field of the Invention

The present invention relates to, for example, a control apparatus for communication between processors which communicates by connecting nodes of computers, each having at least one processor, with a channel.

2. Description of the Related Art

FIG. 8 shows an organization of a conventional communication control apparatus for communication between processors shown in, for example, Japanese Unexamined Patent Publication No. 10-334053. In the figure, reference numerals 1 through 3 show computer nodes performing various kinds of processing, and 4 shows a communication switch which switches and controls the communication among processors of the computer nodes 1 through 3. 5 through 7 denote channels respectively connecting the computer nodes 1 through 3 and the communication switch 4.

Further, each of the computer nodes 1 through 3 includes the following: Namely, reference numerals 10 and 11 denote processors, that is, CPUs, each performing various kinds of processing. 12 and 13 are bridges respectively connecting the CPUs 10 and 11 and their peripheral circuits. 14 and 15 denote memories respectively storing instructions and data etc. processed by the CPUs 10 and 11. 16 shows a communication control apparatus processing the communication with a processor of another computer node. 17 shows a bus connecting the communication control apparatus 16 and each of the bridges 12 and 13.

Further, the communication control apparatus 16 includes the following: A reference numeral 20 shows a bus interface unit controlling interface with the bus 17, and 21 shows a channel interface unit controlling interface with the channel 5. 22 shows a send controller controlling sending process of data of the communication between the processors, and 23 shows a receive controller controlling receiving process of data of the communication between the processors.

An operation of the communication according to the conventional method for communication between the processors will be explained for an example case where the computer node 1 sends data to the computer node 2. The CPU 10 of the computer node 1 performs various kinds of processing based on instructions and data stored in the memory 14. The bridge 12 controls sending/receiving instructions and data between the CPU 10 and the memory 14.

The CPU 10 controls sending process of data by controlling the communication control apparatus 16. At this time, the CPU 10 first generates send control information and send data on the memory 14. Next, the CPU 10 provides an address of the send control information to the communication control apparatus 16, and then activates the communication control apparatus 16. The activated communication control apparatus 16 reads the send data from the memory 14 using the interpreted result read from the address of the memory 14 and transfers the data to the channel 5.

FIG. 9 shows the send control information and the send data generated on the memory 14 by the CPU 10. A reference numeral 100 shows memory contents stored in the memory 14, including the following two main contents: One is send control information 101 and the other is send data 102. 103 through 108 denote contents of the send control information 101: 103 is a send data length; 104 is interrupt control information controlling generation of send-end interrupt; 105 is a send data address to specify the send data 102; 106 is a receive node identifier indicating the computer node which receives the send data 102; 107 is a receive connection identifier of logical connection used in sending process of data at the receiver; and 108 is a send connection identifier of logical connection used in sending process of data at the sender.

Hereinafter, an explanation will be done assuming that an operating system observes and activates all tasks through the CPU, and further, the task operates through the CPU. It can be considered that the CPU executes the operation of the OS and the task, however, the following description will be mainly performed in the former manner.

The activation of the communication control apparatus 16 will be explained in the following. After generating the send control information 101 and the send data 102 on the memory 14, the CPU 10 activates the communication control apparatus 16 to send data. First, the CPU 10 sets an address for the send control information 101 in the send controller 22 within the communication control apparatus 16, and then activates sending process. At this time, the address for the send control information 101 is set in an address register, which is not shown in the figure, within the send controller 22 via the bus interface unit 20 of the communication control apparatus 16. The activation of sending process is instructed by a write request on a send activation register, which is not shown in the figure either, within the send controller 22.

The address register and the send activation register are mapped within the address domain of the CPUs 10 and 11. In order to respond to sending request from plural tasks of each CPU, the CPU executing an operating system (hereinafter, referred to as OS) generally manages and controls the sending process. Accordingly, the activation of the sending process of the communication processing apparatus 16 is always controlled by the CPU using the function of the OS based on the sending request from each of the above tasks.

When the sending process is activated, the send controller 22 first requests the bus interface unit 20 to read from the address for the send control information 101. The bus interface unit 20 sends the address of the send control information 101, and issues read request from that address. The above address and the read request is detected by the bridge 12 and is judged that they are the contents of the memory 14. The send control information 101 stored in the address is read from the memory 14 and output to the bus 17. The bus interface unit 20 takes in the send control information 101 from the bus 17 and supplies the send control information to the send controller 22. Through the above steps, the send controller 22 of the communication control apparatus 16 obtains the send control information 101 necessary for controlling sending process of data.

Next, the send controller 22 controls sending process of the send data 102 according to the obtained send control information 101. First, the send controller 22 requests the bus interface unit 20 to read data having data size indicated by the send data length 103 from the address indicated by the send data address 105 within the send control information 101. The bus interface unit 20 outputs the send data address 105 to the bus 17 and issues the read request from the address. The above address and the read request is detected by the bridge 12 and is judged that they are the contents of the memory 14. The send data 102 stored in the address is read from the memory 14 and output to the bus 17. The bus interface unit 20 takes in the send data 102 on the bus 17 and supplies the send data to the send controller 22.

Subsequently, the send controller 22 supplies the send data length 103, the receive node identifier 106, the receive connection identifier 107, the send connection identifier 108 within the send control information 101 and the send data 102 to the channel interface unit 21, and requests to send data to the channel 5. On receiving the request, the channel interface unit 21 controls the channel 5 to send sequentially a header consisting of the send data length 103, the receive node identifier 106, the receive connection identifier 107 and the send connection identifier 108, and the send data 102.

When the above sending process is completed, the send controller 22 checks the interrupt control information 104 within the send control information 101. If the generation of the send-end interrupt is enabled, the send controller 22 generates the send-end interrupt to the CPU 10 (any way to generate can be involved), and the CPU 10 detects the send-end. On the contrary, if the generation of the send-end interrupt is disabled, the send-end interrupt is not generated.

The above header and the send data 102 sent from the computer node 1 via the channel 5 is transferred to the communication switch 4. The communication switch 4 checks the receive node identifier 106 in the header. If the header and the send data are discriminated that they are destined to the computer node 2, the communication switch sets the communication channel to the channel 6 connecting to the computer node 2 and transfers the header and the send data.

In the computer node 2, the channel interface unit 21 of the communication control apparatus 16 takes in the header and the send data 102 and supplies them to the receive controller 23. The receive controller 23 determines a receive buffer address (any way to determine can be involved) to store the send data 102 based on the receive connection identifier 107 included in the header. The receive controller 23 requests the bus interface unit 20 to write the send data 102 on the receive buffer address. The bus interface unit 20 outputs the receive buffer address and the send data 102 to the bus 17 to issue the write request to the address. The receive buffer address and the write request detected by the bridge 12 or 13 is judged that it is the write request on the memory 14 or 15, and the send data 102 is stored in that address.

Finally, the receive controller 23 informs the CPU 10 or 11 of the receipt of the data by some means (any means can be involved). Through the above process, the communication process between the processors from the computer node 1 to the computer node 2 has been completed. Then, the computer node 2 processes the contents of the send data 102 properly.

Within the above communication process between the processors, time consumed for the data sending process will be explained referring to FIG. 10. In FIG. 10, reference numerals 400 through 402 show times required for the sending process of the bus 17: 400 shows an activation time required for activating the communication control apparatus 16 by the CPU 10; 401 shows a control information reading time required for obtaining the send control information 101 by the communication control apparatus 16; and 402 shows a data reading time required for obtaining the send data 102 by the communication control apparatus 16. 410 and 411 show times required for sending the data to the channel 5, 410 shows a header sending time required for sending the header consisting of the send data length 103, the receive node identifier 106, the receive connection identifier 107, and the send connection identifier 108, and 411 shows a data sending time required for sending the send data 102. 420 shows a sending processing time required for a series of sending process.

Conventionally, the communication apparatus for communication between the processors is constituted as described above, having a problem of long sending processing time.

Namely, the send data 102 cannot be obtained until the CPU 10 activates the communication control apparatus 16, and the communication control apparatus 16 obtains the send control information 101 from the memory 14 and interprets the contents. The communication control apparatus 16 obtains the send data 102, outputs the header to the channel 5 to set the communication channel, and then the send data 102 is output to the channel 5. Accordingly, the sending processing time 420 becomes greater than a sum of the activation time 400, the control information reading time 401, the data reading time 402, the header sending time 410, and the data sending time 411, which makes the time required for the sending process long, and decreases the system performance.

Further, controlling the activation of the sending process of the communication control apparatus 16 is always independently performed through the OS based on the sending request from each task, which generates processing overhead of the OS by the CPU, and might decrease the system performance.

### SUMMARY OF THE INVENTION

The present invention is provided to solve the above problems. The invention eliminates reading the control information from the memory by the processor, reduces the sending processing time, and improves the system performance. Further, the transferring process to the channel is performed in parallel with the reading process of the send data, which also reduces the sending processing time, and improves the system performance.

Further, the processor is not always required to control the activation of sending process using the communication processing apparatus through the OS, namely, the activation can be triggered by the processor directly from each task, for which the processor activates the sending process. In this way, the invention eliminates the processing overhead of the OS, and improves the system performance.

According to the present invention, an independent communication control apparatus, connected to a processor executing an operating system (OS) and an application and connected to a memory, for sending data to an outside device via a channel, includes:

a communication control information table for specifying send control information received from the processor, and

wherein the independent communication control apparatus starts to send data to a receiver specified in the send control information on receiving a send activation instruction from the processor, and reads data from the memory based on the send activation instruction from the processor and contents of the communication control information table.

According to another aspect of the present invention, a method for independent communication control having a communication controller connected to a processor executing an operating system (OS) and connected to a memory, for sending data to an outside device via a channel, and wherein the communication controller has a communication control information table for specifying send control information from the processor,

the method includes:

specifying an address of the memory based on a send activation instruction from the processor and contents of the communication control information table; and

starting to send data to a receiver by reading the data from the memory.

These and other objects and features of the invention will be better understood by reference to the detailed description which follow taken together with the drawings in which like elements are referred to by like designations throughout the several views.

### BRIEF EXPLANATION OF THE DRAWINGS

In the drawings, FIG. 1 shows an organization of a send controller (apparatus) within a computer node according to the first embodiment of the present invention;

FIG. 2 shows an example of memory area assigned to send data according to the first embodiment;

FIG. 3 shows an example of memory area assigned to send status according to the first embodiment;

FIG. 4 shows an example of address domain area in the memory for sending process;

FIG. 5 explains sending processing time according to the first embodiment;

FIG. 6 shows an organization of a send controller within a computer node according to the second embodiment of the present invention;

FIG. 7 is a flow diagram showing an operation when the communication controller is performed by a general computer having the means of program of the flow diagram;

FIG. 8 shows a system organization of a conventional control apparatus for communication between the processors, which shows an organization of a general computer node;

FIG. 9 shows an example of send control information and send data on a memory according to the conventional control apparatus for communication between the processors; and

FIG. 10 explains sending processing time required for the conventional control apparatus for communication between the processors.

### DESCRIPTION OF THE PREFERRED EMBODIMENT

Embodiment 1.

The following explains a data sending apparatus in which a processor executing a task or an operating system (hereinafter, referred to as OS) initially instructs a send controller to activate sending process, the send controller receives control information by a new element, a header is sent immediately after the activation of the sending process, and the data is sent in parallel with reading the data.

FIG. 1 shows an organization of a send controller of a communication apparatus for communication between the processors according to the present embodiment. In the figure, except for new elements explained in the following paragraph, the elements bearing the same numerals as ones described in the above related art such as a channel 5; a bus 17; a bus interface unit 20; a channel interface unit 21; and a send controller 22 have the same function.

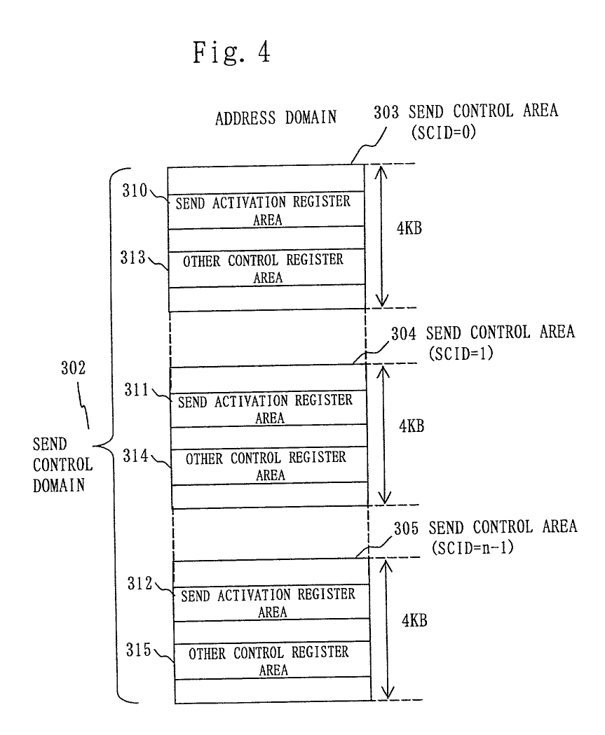

The following new elements are provided in the send controller 22 for reducing the time required for sending process: Namely, a reference numeral 30 denotes a send activation register for activating the sending process; 31 denotes a register access signal for accessing the send activation register 30; 32 denotes a send buffer number which is output from the send activation register 30; 33 shows send data length information which is output from the send activation register 30; 40 shows a send control information table (or, generally referred to as a communication control table) for storing the send control information; 41 shows a send connection identifier for indexing the send control information table 40; 42 shows a queue buffer for temporally buferring the register access signal 31 and the send connection identifier 41; and 43 shows send control output information which is output from the send control information table 40. The area for accessing the send activation register 30 is a part of a send control domain 302, which is shown in FIG. 4 described later, viewed from the processor's side which operates the OS.

The send control output information 43 further includes the following information. Namely, the output information 43 is constituted by a receive node identifier 44, a receive connection identifier 45, a send buffer base address 46, and a send status base address 47. 50 shows an adder for adding an offset of send data address, 51 shows a send data address signal, 52 shows an adder for adding an offset of send status address, 53 shows a send status address signal, and 54 shows a send data signal.

Hereinafter, new send control operation performed by the CPU executing the OS and by the send controller will be explained.

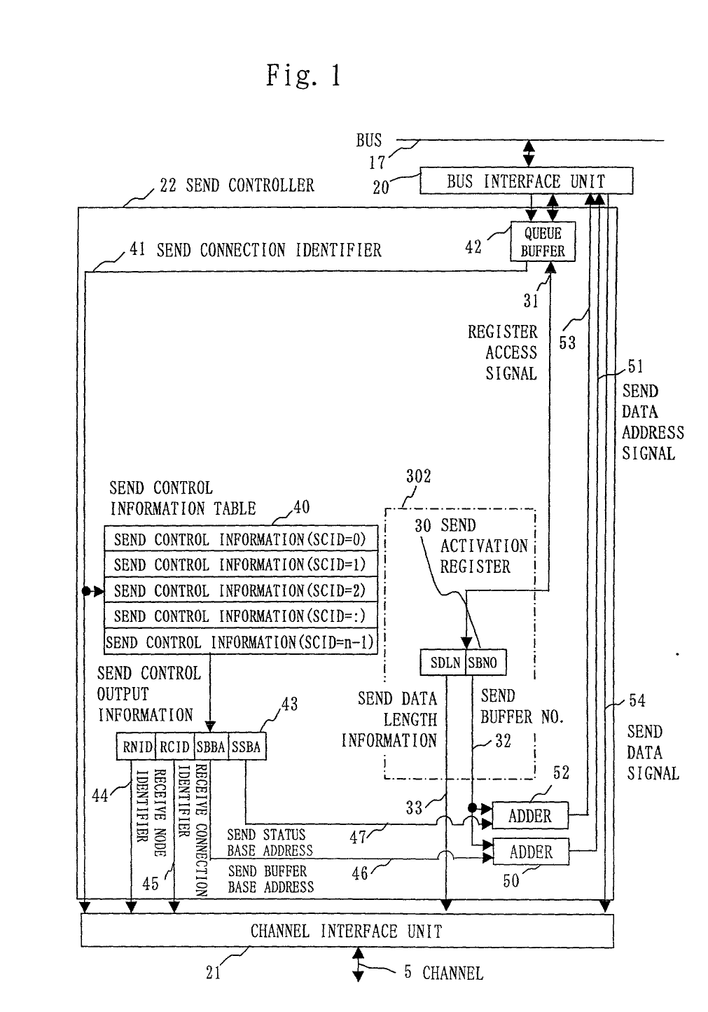

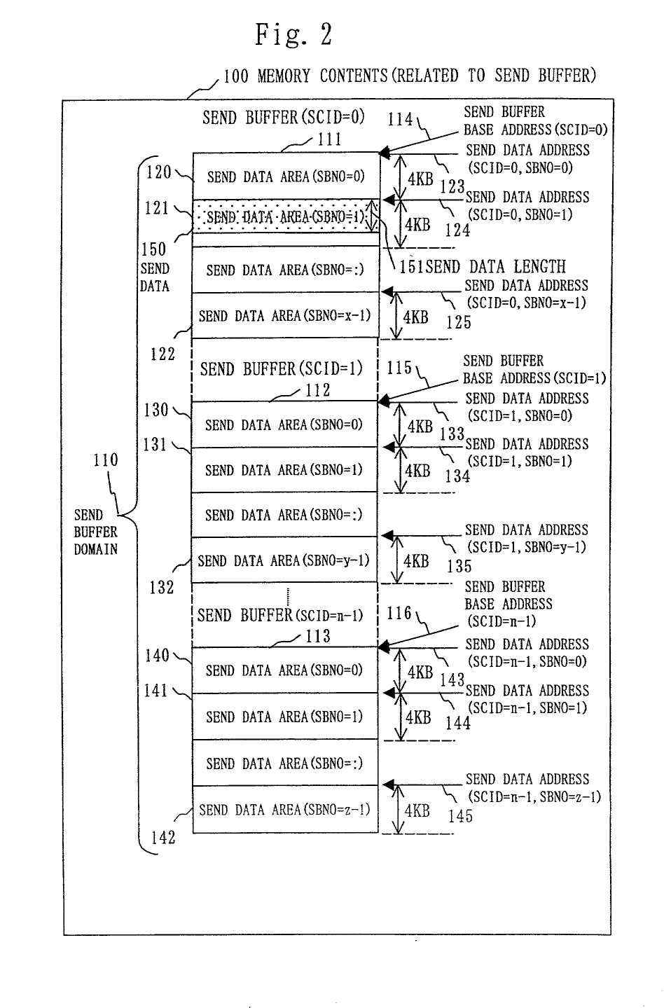

First, the CPU 10 allocates a send buffer area to store the send data in the memory 14. This method will be described referring to FIG. 2. In the figure, 100 shows memory contents related to the send buffer stored in the memory 14; 110 shows a send buffer domain allocated in the memory 14 to store the send data; 111 through 113 show send buffers, each of which corresponds to each of send connection identifier (SCID) within the send buffer domain 110; and 114 through 116 show send buffer base addresses indicating starting addresses of the send buffers 111 through 113.

Further, 120 through 125 show organization of the send buffer 111: 120 through 122 show send data areas to store send data, each of which corresponds to each of the send buffer numbers (SBNO); 123 through 125 show send data addresses, each of which indicates a starting address of each of the send data areas 120 through 122. Similarly, 130 through 135 show organization of the send buffer 112: 130 through 132 show send data areas to store send data, each of which corresponds to each of the send buffer numbers (SBNO); 133 through 135 show send data addresses, each of which indicates a starting address of each of the send data areas 130 through 132. 140 through 145 show organization of the send buffer 113: 140 through 142 show send data areas to store send data, each of which corresponds to each of the send buffer numbers (SBNO); 143 through 145 show send data addresses, each of which indicates a starting address of the send data areas 140 through 142. 150 shows send data which is actually sent, and 151 shows a send data length of the send data 150.

The CPU 10 allocates the send buffer domain 110 in the memory 14 before actually controlling sending process of data. The send buffer domain 110 is divided into the number of logical connections (the number is assumed to be n in the present embodiment), that is, into the send buffers 111 through 113, each of which corresponds to each of the logical connections. The send buffers 111 through 113 respectively consist of x pieces of the send data areas 120 through 122, y pieces of the send data areas 130 through 132, and z pieces of the send data areas 140 through 142.

Here, each of the send data areas 120-122, 130-132, and 140-142 has a size of a multiple of managing size (4 KB, in the present embodiment) which is managed by the OS as a unit of send data. Consequently, when each of the send buffers 111 through 113 is assigned to a different task which is executed on the CPU 10, each send data area available to each task can be limited and protected using the space protecting function (any protection method can be involved) which is generally provided by the OS running on the CPU. The figure shows an example in which a space is inserted to each of between addresses of the send buffers 111 through 113, however, this space can be omitted.

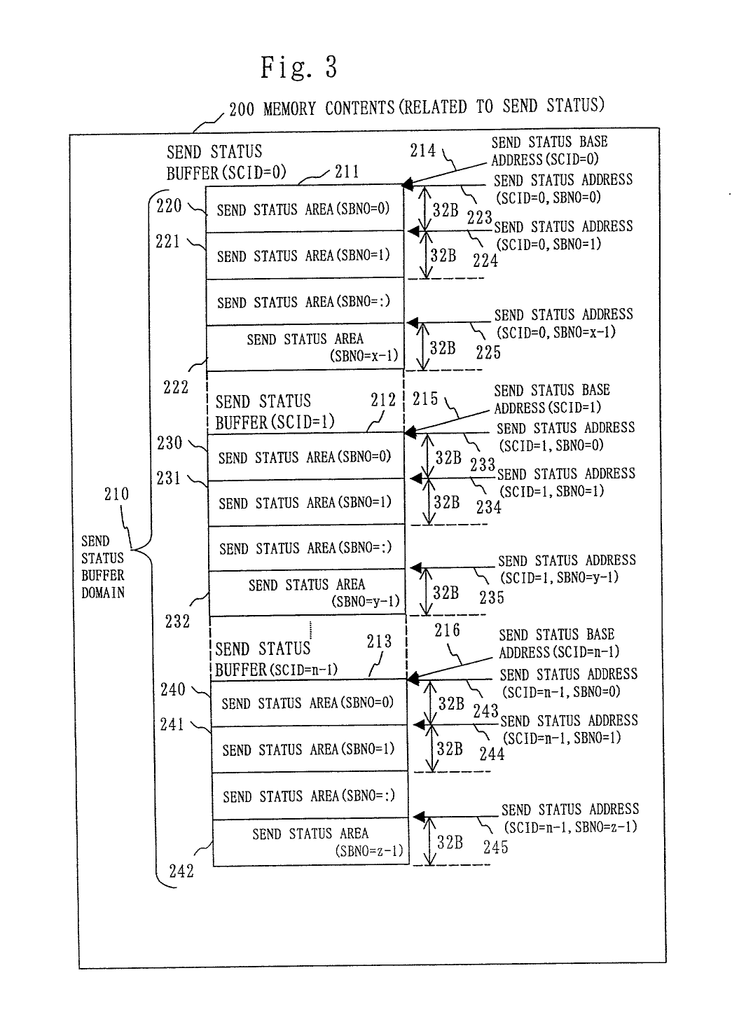

Further, the CPU 10 allocates the send status buffer area in the memory 14 to store the status of sending process by the communication control apparatus 16. This method will be explained referring to FIG. 3. In the figure, 200 shows contents of the memory related to the send status buffer stored in the memory 14, 210 shows a send status buffer domain allocated in the memory 14 for storing the send status, 211 through 213 show send status buffers, each of which corresponds to each of the send connection identifiers (SCID) within the send status buffer domain 210, and 214 through 216 show send status base addresses, each of which indicates a starting address of each of the send status buffers 211 through 213.

Yet further, 220 through 225 show organization of the send status buffer 211. 220 through 222 show the send status areas to store the send status, each of which corresponds to each of the send buffer numbers (SBNO). 223 through 225 show send status addresses, each of which indicates a starting address of each of the send status areas 220 through 222. Similarly, 230 through 235 show organization of the send status buffer 212. 230 through 232 show the send status areas to store the send status, each of which corresponds to each of the send buffer numbers (SBNO). 233 through 235 show send status addresses, each of which indicates a starting address of each of the send status areas 230 through 232. 240 through 245 show organization of the send status buffer 213. 240 through 242 show the send status areas to store the send status, each of which corresponds to each of the send buffer numbers (SBNO). 243 through 245 show send status addresses, each of which indicates a starting address of each of the send status areas 240 through 242.

The CPU 10 allocates the send status buffer domain 210 in the memory 14 before actually controlling sending the data. The send status buffer domain 210 is divided into the number of logical connections (the number is assumed to be n in the present embodiment), that is, into the send status buffers 211 through 213, each of which corresponds to each of the logical connections. The send status buffers 211 through 213 respectively consist of x pieces of the send status areas 220 through 222, y pieces of the send status areas 230 through 232, and z pieces of the send status areas 240 through 242.

More than one of the send status buffers 211 through 213 should not be included within one space management unit managed by the OS. By configuring like this, it becomes possible to assign a certain send status of a certain logical connection and another send status of another logical connection to different tasks independently, which prevents mutual interference. Further, plural send status areas should not be included in one cache line (32B in the present embodiment) of the CPU 10. By configuring like this, it becomes possible to detect the send status by the CPU 10 and to prevent the interference to the write operation of the send status by the communication control apparatus 16. The figure shows an example in which a space is inserted to each of between the addresses of the send status buffers 211 through 213, however, the space can be omitted.

On starting controlling the sending process using a certain logical connection (for example, it is assumed the send connection identifier SCID=0), the CPU 10 at the sender's side first sets the send control information consisting of the receive node identifier, the receive connection identifier, the send buffer base address, and the send status base address related to the logical connection in an entry (SCID=0) of the send control information table 40 corresponding to the logical connection under management of the OS (any setting method can be involved). Within the communication between the processors using a certain logical connection, same values are always used for the send control information unless the send control information is newly set into the entry of the send control information table.

Next, the CPU 10 generates the send data 150 to be sent. For example, in case of the send connection identifier SCID=0, when data is generated in the send buffer number SBNO=1, the send data 150 is stored from the top of the send data area 121 as shown in FIG. 2. The send data length 151 should be equal to or less than 4 KB, which is the size of the send data area.

As described above, after the send buffer domain 110 is allocated, the send status buffer domain 210 is allocated, the send control information table 40 is set, and the send data 150 is generated, the CPU 10 activates the sending process of the communication control apparatus 16. Allocating the send buffer domain 110 and the send status buffer domain 210 should be performed only once before the activation of the sending process by the CPU 10. Further, the send control information table 40 should be set only once per logical connection before the activation of the sending process by the CPU 10.

The above operation will be described referring to FIG. 4 which shows the send control domain provided to the send controller 22.

The CPU 10 allocates domains to be used in the sending process in the memory 14. Namely, the send buffer domain 110 and the send status buffer domain 210 are allocated. Further, the send control domain is assigned to the send controller 22 as shown in FIG. 4. In the figure, 302 denotes the send control domain for controlling the sending process of data. 303 through 305 show the send control areas constituting the send control domain 302, respectively correspond to 0, 1, n−1 of the send connection identifier (SCID). 310 through 312 are send activation register areas included in the send control areas 303 through 305 and used for accessing the send activation register 30. 313 through 315 show other control register areas included in the send control areas 303 through 305 and used for accessing the registers except the send activation register 30.

Although there are plural send activation register areas 310 through 312 and plural other register areas 313 through 315, substantial numbers of the send activation register 30 and the other control register set corresponding to these register areas are not limited. For example, one set of the send activation register 30 and the other control register set can be made accessible from plural send activation register areas 310 through 312 and the other control register areas 313 through 315. In another way, plural sets of the send activation register 30 and the other control register set can be provided, and these sets can be made respectively corresponding to the send activation register areas 310 through 312 and the other control register areas 313 through 315.

Further, each of the send control areas 303 through 305 has a size of multiple of the managing unit (4 KB, in the present embodiment) managed by the OS, and is set corresponding to the logical connection. Namely, the send control areas 303 through 305 respectively correspond to 0, 1, n−1 of the send connection identifier (SCID). The OS maps each of the send control areas 303 through 305 within the task space where the communication between the processors is performed using the send connection identifier (SCID) corresponding to the send control areas 303 through 305. By this mapping, it becomes possible to limit and protect the logical connection employed by each task using the space protecting function (any protecting method can be employed) which is generally provided by the OS.

In case that the CPU 10 activates sending process of the data stored in the send buffer number (SBNO) 1 using the send connection identifier (SCID) 0, the CPU 10 writes a combination of the send buffer number (SBNO=1) and the send data length 151 onto the send activation register area 310 corresponding to the send connection identifier (SCID=0).

On detecting the write from the CPU 10, the bridge 12 transfers the write to the bus 17. The bus interface unit 20 of the communication control apparatus 16 detects that the address of the write request of the bus 17 is the send control domain, the write request of the bus 17 is responded, and the write request is further provided to the send controller 22.

The send controller 22 once stores the write request in the queue buffer 42. By storing this way, the bus interface unit 20 is made capable to accept the subsequent send activation request before the sending process being performed by the send controller 22 has been completed. Therefore, the bus 17, the bridge 12 and the CPU 10 can finish transferring the send activation request without waiting for completion of the sending process being performed by the send controller 22.

The write request once stored in the queue buffer 42 is output as a register access signal 31 and a signal for the send connection identifier 41. At this time, if another sending request was previously accepted, the write request is output after finishing the sending process for that previous request. Here, the register access signal 31 is the data requested to write (namely, a combination of the send buffer number and the send data length 151) and information indicating that an object to write is the send activation register 30. The send connection identifier 41 can be easily generated by extracting a part of the address information included in the write request (namely, the address of the send activation register area 310).

On receiving the register access signal 31, the send activation register 30 takes in the contents of the signal. Then, the send activation register triggers to send the data to the channel immediately after the activation of the register. Here, there is one send activation register 30, and the send activation register can be activated immediately by the write operation. Further, the register includes two parts (SBNO and SDLN): the send buffer number within the register access signal 31 is written in the SBNO, and the send data length is written in the SDLN. The written results are output as the send buffer number 32 and the send data length information 33 to supply to the adders 50, 52 and the channel interface unit 21.

On the other hand, the send control information table 40 selects an entry using the send connection identifier 41 as an index and outputs the send control output information 43. The send control output information 43 includes the receive node identifier 44 (RNID), the receive connection identifier 45 (RCID), the send buffer base address 46 (SBBA), and the send status base address 47 (SSBA). This send control information has been stored under management of the OS in the send control information table 40, and is selected in send control information table and output from it.

The send buffer number 32 is added to the send buffer base address 46 output from the send control information table 40 as offset information in the adder 50 to generate the send data address signal 51. As shown in FIG. 2, since the size of each send data areas is 4 KB unit, a value obtained by multiplying 4 KB to the send buffer number 32 is added to the send buffer base address 46 as the actual offset value, which generates the send data address signal 51.

On supplying the send data length information 33 to the channel interface unit 21 from the send activation register 30, the channel interface unit 21 starts the sending process. First, by outputting the send data length information 33, the send connection identifier 41, the receive node identifier 44, and the receive connection identifier 45 to the channel 5 as the header information, the channel interface unit 21 controls a communication switch 4 to set the communication path. By this setting, after establishing the communication path of the data between the channel 5 and the channel of the receiver's side (for example, the channel 6), the communication switch 4 sends the header information to the receiver's computer node (for example, the computer node 2).

In parallel with controlling to set the communication path, the send controller 22 obtains the send data 150 to supply to the channel interface unit 21. Concretely, the send controller 22 requests the bus interface unit 20 to read data having a size indicated by the send data length information 33 from the address indicated by the send data address signal 51 in a predetermined method, which is not shown in the figure. The bus interface unit 20, which receives the read request, outputs the address and the read request to the bus 17.

On detecting the reading request, the bridge 12 recognizes the received address as the address in the memory 14, and the send data 150 indicated by the above address is selected from the memory 14 and output to the bus. The bus interface unit 20 takes in the send data 150 and transfers the data to the channel interface unit 21 as the send data signal 54.

After completion of controlling setting of the communication path, the channel interface unit 21 controls sending process of the send data 150 to the channel 5 by the size of the send data length information 33. The send data 150 is transferred to the communication switch 4 via the channel 5, and reached to the computer node 2 by the operation of the communication switch 4 via the channel 6 of the receiver's side. The receiving process of the send data 150 performed by the computer node 2 is the same as the conventional communication method for the communication between the processors, and an explanation will be omitted here.

On finishing sending process of the send data 150, the result is written in the memory 14 as the send status. The send buffer number 32 is added to the send status base address 47 output from the send control information table 40 at the adder 52 as the offset information, and the send status address signal 53 is generated. As shown in FIG. 3, since each of the send status areas consists of 32B unit, a value obtained by multiplying 32B to the send buffer number 32 is added to the send status base address 47 as the actual offset value, which becomes the send status address signal 53. The send controller 22 requests the bus interface unit 20 to write in a predetermined way (not shown in the figure) to store the status information (the contents are not limited) of the data sending process in the send status address obtained above.

The bus interface unit 20 outputs the address, the status information and the write request to the bus 17. The bridge 12 writes the status information in the send status area 221 indicated by the above address (namely, the send status address 224) in the memory 14. The CPU 10 reads the send status address 224 and checks the status information so that the CPU 10 confirms the completion and successful completion/failure of the sending process of the communication between the processors.

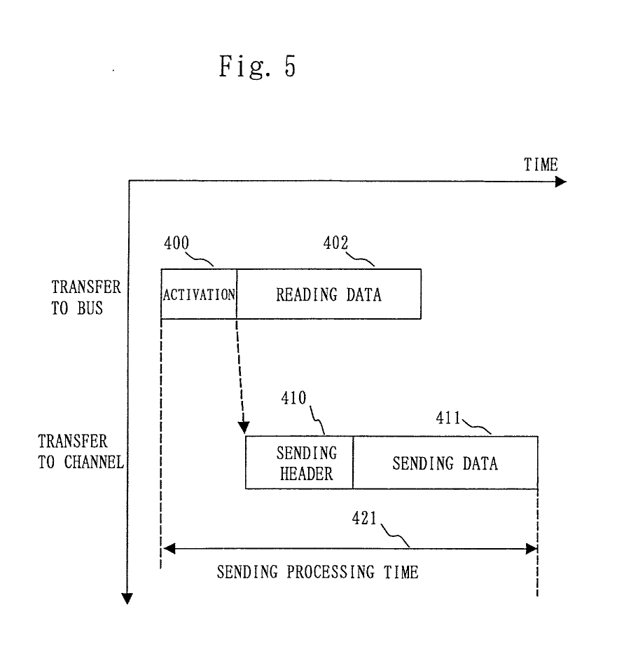

Among the above processes of the communication between the processors, time consumed for the sending process will be explained referring to FIG. 5. In the figure, 400 and 402 denote time required for the transferring process performed through the bus 17: 400 shows the activation time required for activating the communication control apparatus 16 by the CPU 10; and 402 denotes the data reading time required for obtaining the send data 150 by the communication control apparatus 16. 410 and 411 show time required for the transferring process to the channel 5: 410 shows the header sending time required for sending the header which consists of the send data length information 33, the send connection identifier 41, the receive node identifier 44, and the receive connection identifier 45; and 411 shows the data sending time required for sending the send data 150. 421 denotes the sending processing time required for a series of the sending process.

As has been described, in the communication apparatus for the communication between the processors according to the present invention, after the CPU 10 activates the communication control apparatus 16, the send controller 22 independently performs the sending process based on the send control information stored in the send control information table 40. Therefore, it becomes unnecessary to obtain the send control information from the memory 14, which was conventionally necessary, and the time required for the sending process can be reduced. The communication control apparatus 16 controls setting of the communication path by transferring the header in parallel with obtaining the send data 150, which further reduces the time required for the sending process.

In the above explanation, between the CPUs 10 and 11 constituting the computer node 1, only the CPU 10 controls the sending process. Another case in which both of the CPUs 10 and 11 respectively control the sending process will be explained in the following.

For example, it is assumed that a logical connection corresponding to a certain send connection identifier (SCID=0) is assigned to a task which is executed on the CPU 10, and that another send connection identifier (SCID=1) is assigned to a task which is executed on the CPU 11.

In this case, the send buffer 111 and the send status buffer 211 corresponding to SCID=0 are allocated in the memory 14 accessible from the CPU 10, and are allowed for only the task executed on the CPU 10 to trigger to access by the function of the OS. Similarly, the send buffer 112 and the send status buffer 212 corresponding to SCID=1 are allocated in the memory 15 accessible from the CPU 11, and are allowed for only the task executed on the CPU 11 to trigger to access by the function of the OS.

Under the management of the OS, among the send control domain 302 shown in FIG. 4, the send control area 303 corresponding to SCID=0 is assigned to the task executed on the CPU 10, and the send control area 304 corresponding to SCID=1 is assigned to the task executed on the CPU 11. By this assignment, the task executed on the CPU 10 is allowed to trigger to control the sending process of data to the communication control apparatus 16 by accessing the send control area 303, however, is prohibited from triggering to access the send control area 304 (as for prohibiting method, space management by the OS is generally employed, however, the method is not limited here).

Similarly, the task executed on the CPU 11 is allowed to trigger to control the sending process of data to the communication control apparatus 16 by triggering to access the send control area 304, however, is prohibited from triggering to access the send control area 303.

As for the entry of the send control information table 40, under the management of the OS, various pieces of the send control information to be used for the communication by the task executed on the CPU 10 are set in the entry corresponding to SCID=0. Similarly, various pieces of the send control information to be used for the communication by the task executed on the CPU 11 are set in the entry corresponding to SCID=1. These settings are managed by the OS, so that the information cannot be improperly modified by tasks.

By the above organization, it is possible for the CPUs 10 and 11 executing the tasks to control the sending process using only areas allowed to access for each task and setting through the OS (the setting has generally few errors and it is prohibited to change improperly the contents of the setting for each task). In this way, the CPUs 10 and 11 can perform sending process for each task safely using the communication control apparatus 16 without any influences from the other task.

In the above explanation, the tasks are executed on different CPUs, the CPU 10 and the CPU 11. The present embodiment can be applied to a case in which a single CPU (for example, the CPU 10) executes different tasks. Namely, a single CPU can perform the sending process for plural tasks using the communication control apparatus 16 without any influence from the other task by allocating the send control area for each task and by exclusively setting the corresponding send control information table.

As discussed above, according to the present embodiment, the send buffer, the send status buffer, and the send control area corresponding to the logical connection used by the task are assigned to an arbitrary task executed on an arbitrary CPU of a certain computer node, and the entry of the send control information table corresponding to the logical connection is set under the management of the OS. Therefore, the CPU performs the sending process for each task using the communication control apparatus 16 without any influence from the other task. Since the OS does not need to manage activation of the sending process, the sending process using the communication control apparatus 16 can be activated for each task without requesting the OS to activate the sending process. Consequently, the overhead of the OS can be eliminated.

As has been described, according to the present invention, the communication control information table is provided to the communication control apparatus side. On receiving the send activation instruction of from the processor, the communication control apparatus independently read data from the memory and starts sending process of data. Consequently, time required for reading control information is eliminated, which decreases time required for sending process, and the overhead of the OS is also eliminated.

Further, the communication control apparatus reads data from the memory based on the address information, and sends data in parallel with reading the data, which reduces the sending processing time.

Further, the send activation instruction includes the send data length, and the communication apparatus sends data as a set by the data length specified in the activation instruction, which enables the task to generate communication instruction.

Further, the size of each send control area is one or multiple of the space management unit of the OS, which facilitates the management of the communication by the OS.

Further, the task executed on the processor supplies the send activation instruction to the send control area, which enables the processor to control sending process directly from the task.

Further, an address of the send data and an address of the send status are obtained by operating a predetermined addition/subtraction on the address of the memory specified in the communication control information table and address information specified in the send activation instruction, which decreases the data amount given by the send activation instruction and reduces the activation time of send process.

Further, the queue buffer is provided for buffering the activation instruction of sending process. The load of the processor can be reduced since the processor can finish the sending process at that time of buffering, which improves the system performance.

Embodiment 2.

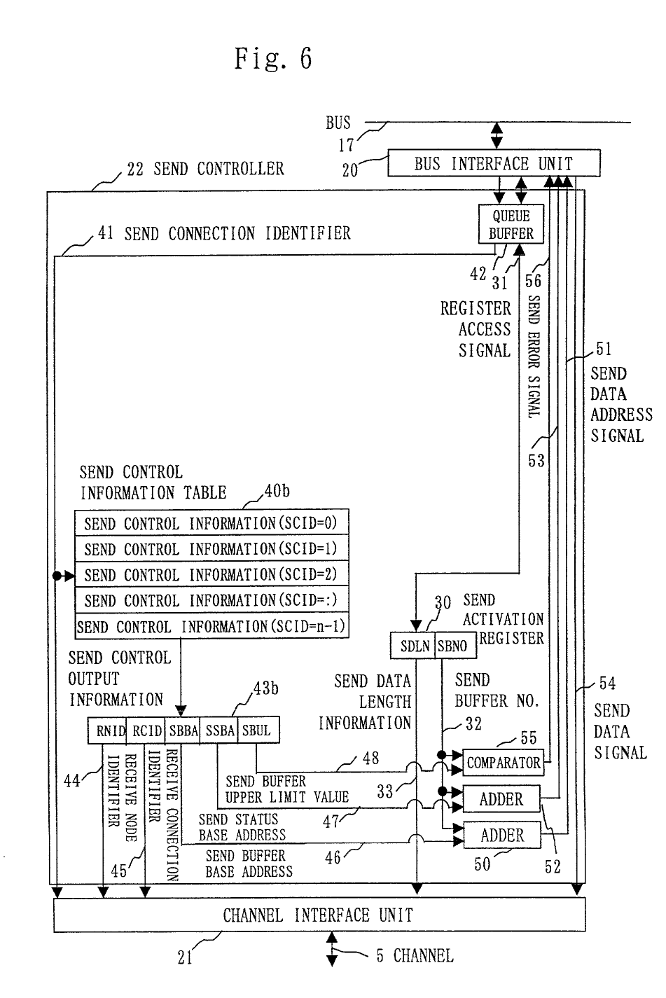

FIG. 6 shows an organization of the send controller according to the second embodiment. In the figure, the elements bearing the same numerals as ones in FIG. 1 are similar elements and an explanation for them is omitted here. As for new elements, a reference numeral 40b denotes a send control information table for storing send control information such as a receive node identifier, a receive connection identifier, a send buffer base address, a send status base address, and a send buffer upper limit value. 43b denotes send control output information output from the send control information table 40b. 48 shows a send buffer upper limit value of the send control output information 43b, 55 shows a comparator, and 56 shows a send error signal.

An operation of the send controller shown in FIG. 6 will be explained hereinafter.

Prior to the actual control of sending process of data, the CPU 10 allocates the send buffer domain 110 and the send status buffer domain 210 in the memory 14 in the same way as the first embodiment (an explanation will be omitted here).

The CPU 10 at the sender's side, on starting control of the sending process of data using a certain logical connection (assuming that the send connection identifier SCID=0), set the send control information related to the logical connection consisting of the receive node identifier, the receive connection identifier, the send buffer base address, the send status base address and the send buffer upper limit value in the entry (SCID=0) of the send control information table 40b corresponding to the logical connection under the management of the OS (any setting method can be employed). Here, since the number of the send buffers corresponding to SCID=0 is x, the send buffer upper limit value is set to x−1.

Next, the CPU 10 generates the send data 150 to be sent in the same way as the first embodiment (the explanation is omitted here). After the send buffer domain 110 is allocated, the send status buffer domain 210 is allocated, the send control information table 40b is set, and the send data 150 is generated, the CPU 10 activates sending process of the communication control apparatus 16 in the same way as the first embodiment.

The send control information table 40b selects the entry based on the send connection identifier 41 provided from the queue buffer 42 as an index and outputs the send control output information 43b. The send control output information 43b includes the receive node identifier 44 (RNID), the receive connection identifier 45 (RCID), the send buffer base address 46 (SBBA), the send status base address 47 (SSBA), and the send buffer upper limit value 48 (SBUL). The send control output information has been stored in the send control information table 40b under the management of the OS, and the send control output information is selected and output.

The send buffer number 32 output from the send activation register 30 is compared with the send buffer upper limit value 48 output from the send control information table 40b by the comparator 55. If the comparison result shows that the send buffer number 32 is equal to or less than the send buffer upper limit value 48, it is discriminated that the send buffer number is correctly indicated, and the send error signal 56 is not issued. As well as the first embodiment, the send data 150 is transferred to the channel 5.

If the comparison result shows that the send buffer number 32 is greater than the send buffer upper limit value 48, it is discriminated that the send buffer number is incorrectly indicated, and the send error signal 56 is issued. Consequently, the CPU 10 is informed of the error by the bus interface unit 20 in a predetermined way, which is not shown in the figure, and simultaneously, the request for sending data to the channel interface unit 21 is suspended.

As has been described, even if an improper send buffer number is indicated to the communication control apparatus 16 because of such as malfunction of the task, for which the sending process is controlled, the present embodiment enables to avoid an improper operation of the sending data or malfunction such as destruction of the status information.

In the above series of the description, the CPUs 10 and 11 respectively include the memories 14 and 15, however, the embodiment can be applied to another organization. For example, the CPUs 10 and 11 share a single memory. Or the memories 14 and 15 can be shared by the CPUs 10 and 11. Further, in the above description, the number of the processors is two, the CPUs 10 and 11, however, the embodiment can be applied to the organization including another number of the processors.

Further, the organization has been explained in which the communication control apparatus 16 is connected to other elements by the bus 17, however, the embodiment can be applied to another organization such as connected by a crossbar switch etc. Further, in the above explanation, the computer node includes one communication control apparatus 16, however, the computer node can include more than one communication control apparatuses 16.

Further, the organization has been explained in which the computer nodes 1 through 3 are connected by the communication switch 4 and the channels 5 through 7, however, the embodiment can be applied to another organization such as the communication using a shared bus or the communication via radio. Further, the number of the computer nodes to be connected is not limited. Yet further, the receiver can be a terminal and so on.

Further, the example case has been explained above in which the header information sent to the channel is constituted by the send data length information 33, the send connection identifier 41, the receive node identifier 44, and the receive connection identifier 45. However, the embodiment is not limited to this organization. For example, only a part of the above information can be sufficient to embody the invention, or another information can be added.

Further, the send control information table can be another organization as long as the send control information table stores the contents required for the communication control apparatus 16 to control sending process of data.

Further, the example case has been explained above in which each size of the send data areas 120-122, 130-132, and 140-142 is 4 KB, however, another size can be used. Each size of the send status areas 220-222, 230-232, and 240-242 is 32B, however, another size can be used. Yet further, in the above example, each size of the send control areas 303-305 is 4 KB, however, another size can be used, or each size can be different.

In the foregoing embodiments, the communication control apparatus 16 and the send controller included therein are hardware organization. Namely, on activated by the CPU, the hardware organization shown in FIGS. 1, 6, etc. starts the data transfer including the header transfer to the channel 5 independently from the CPU 10.

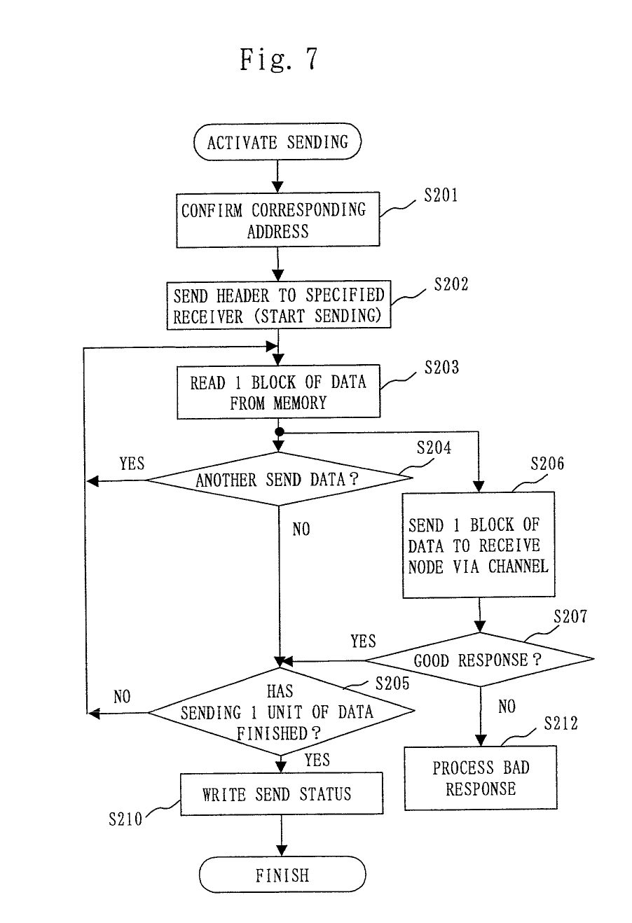

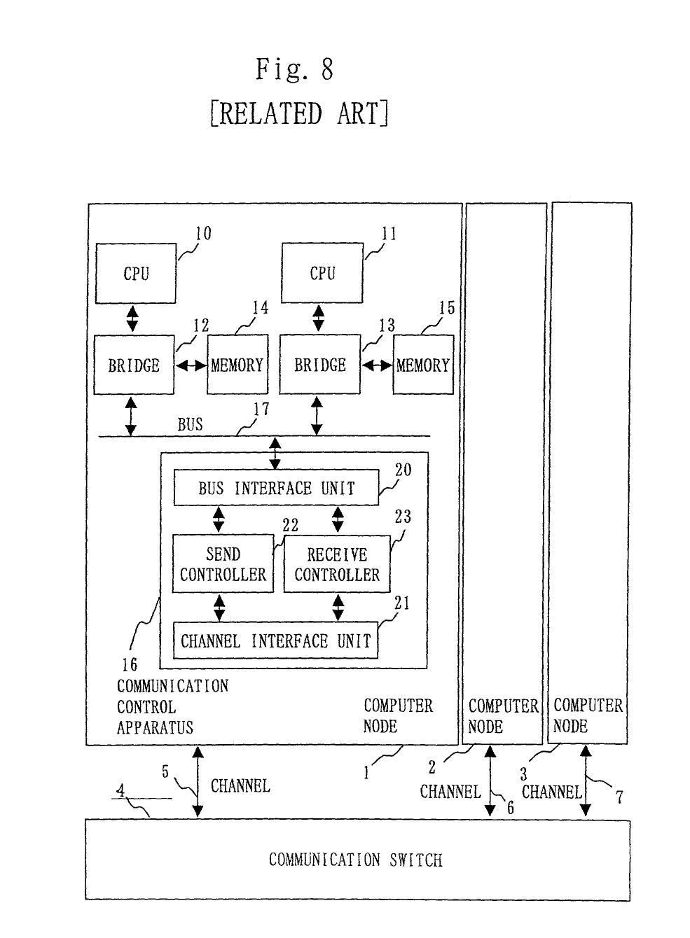

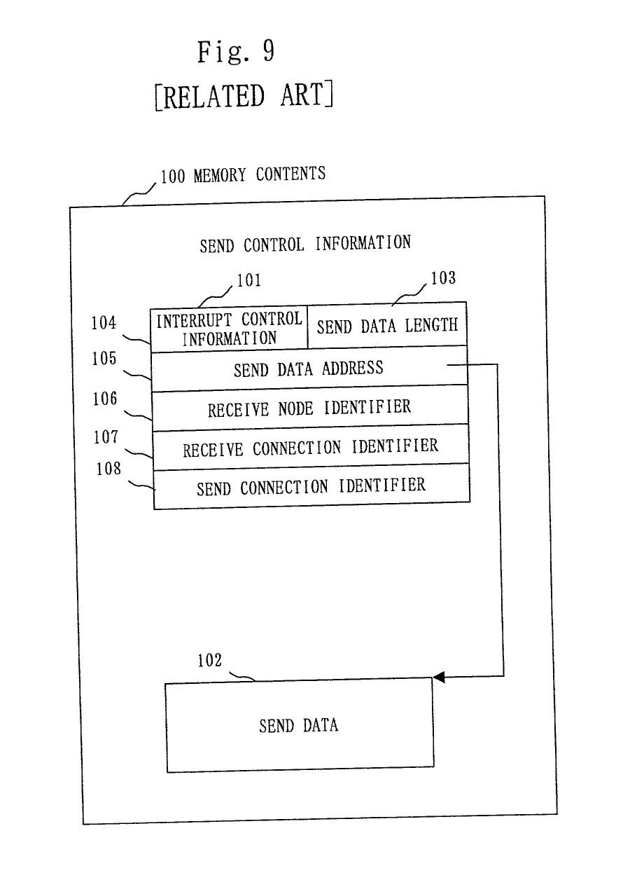

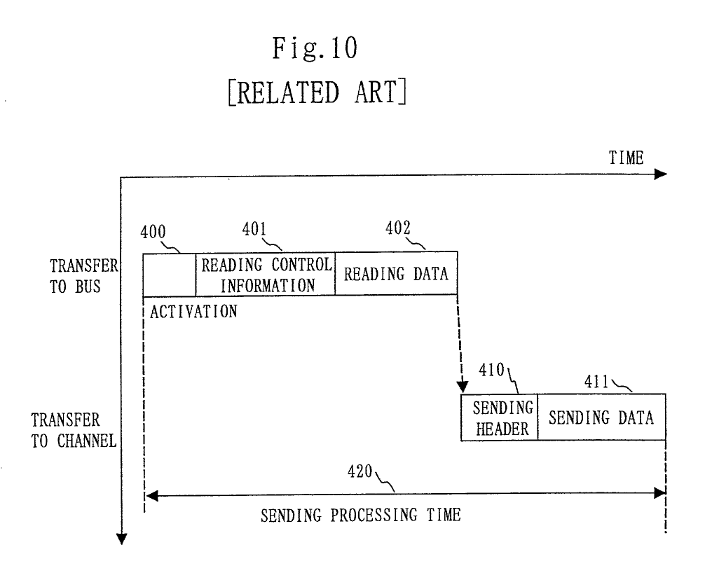

This communication control apparatus or the send controller can be configured by a general-use microprocessor and a memory, and similar function to each element shown in FIGS. 1 and 6 can be provided by software using a control program. Further, another function to control these elements in a whole by a processing flow shown in FIG. 7

When the queue buffer 42 is activated by the CPU 10, at step S201 in the figure, a means corresponding to the send activation register takes in the contents of the queue buffer using the register access signal 31. And then, the header information is transferred to the channel 5 as described in the first embodiment. The transfer to the channel requires more time compared with the access to the memory via the bus. Actually, the reading operation of data from, for example, the send data area 121 of the memory 14 can be performed during the header is being transferred. At least hereinafter, while data to be sent still exists in the memory 14 at step S204, the reading operation of data of next one block at step S203 can be performed in parallel with the data transfer to the channel 5 at step S206.

After one unit of the send data set in the send data area 121 has been transferred at step S205, the send status is written in the send status area 221 at step S210.

Further, since the communication control information table specifies the range of the address of send data in the memory, the malfunction of the operation can be easily detected.

Yet further, since the communication control unit is constituted by the general-use computer and the sending function is provided by the software, the invention can be easily applied to the general-use computer in addition to the above-mentioned effect.

Although the present invention has been described in terms of a preferred embodiment, it will be appreciated that various modifications and alterations might be made by those skilled in the art without departing from the spirit and scope of the invention. The invention should therefore be measured in terms of the claims which follow.

What is claimed is:

1. An independent communication control apparatus, connected to a processor executing an operating system (OS) and an application and connected to a memory, for sending data to an outside device via a channel, comprising:
a communication control information table for specifying send control information received from the processor, and
wherein the independent communication control apparatus starts to send data to a receiver specified in the send control information on receiving a send activation instruction from the processor, and reads data from the memory based on the send activation instruction from the processor and contents of the communication control information table.

2. The independent communication control apparatus of claim 1, wherein the independent communication control apparatus sends the data to the channel in parallel with reading the data from the memory based on address information specified in the send activation instruction.

3. The independent communication control apparatus of claim 1, wherein the processor specifies a send data length in the send activation instruction, and the independent communication control apparatus sends the data at a time as a set of series having the send data length specified in the send activation instruction.

4. The independent communication control apparatus of claim 1,
wherein a send control domain to activate a sending process consists of plural send control areas, a size of which is one or multiple of space management unit of the OS, and each send control area is correspondent to an entry of the communication control table.

5. The independent communication control apparatus of claim 4, wherein the memory has plural send data buffer areas and send status buffer areas corresponding to each task for storing send data and send status.

6. The independent communication control apparatus of claim 4, wherein the processor activates the independent communication control apparatus directly from a task.

7. The independent communication control apparatus of claim 6, wherein only the task assigned to the send control area is allowed to activate the communication control apparatus through the send control area.

8. The independent communication control apparatus of claim 1, wherein an address of send data and an address of send data status are obtained by operating a predetermined addition/subtraction on the address of the memory specified in the communication control information table and address information specified in the send activation instruction.

9. The independent communication control apparatus of claim 1 further comprising a queue buffer for storing the send activation instruction received from the processor, and
wherein the independent communication control apparatus starts to send the data to a receiver based on the send activation instruction stored in the queue buffer.

10. The independent communication control apparatus of claim 9,
wherein the processor sequentially transfers the send activation instruction to the queue buffer of the independent communication control apparatus; and
wherein the independent communication control apparatus executes sending operation according to the send activation instruction stored in the queue buffer, and after finishing the sending operation of one set of data, and performs another sending operation according to a subsequent send activation instruction stored in the queue buffer.

11. The independent communication control apparatus of claim 1, wherein the communication control information table specifies a range of an address of the memory for storing the send data and informs of an error when the sending operation exceeds the range of the address of the memory.

12. A method for independent communication control having a communication controller connected to a processor executing an operating system (OS) and connected to a memory, for sending data to an outside device via a channel, and wherein the communication controller comprises a communication control information table for specifying send control information from the processor,
the method comprises:
specifying an address of the memory based on a send activation instruction from the processor and contents of the communication control information table; and
starting to send data to a receiver by reading the data from the memory.

13. The method for independent communication control of claim 12, the method further comprises:
reading the data from the memory by the communication controller based on address information specified in the send activation instruction; and
sending the data to the receiver in parallel with the reading.

14. The method for independent communication control of claim 12,
wherein the communication controller further comprises a queue buffer for storing the send activation instruction received from the processor, and
wherein starting to send data to the receiver by the communication controller is done based on the send activation instruction stored in the queue buffer.

15. The method for independent communication control of claim 12,
wherein the processor specifies a send data length in the send activation instruction, and
the method further comprises sending the data at a time as a set of series having the send data length specified in the send activation instruction.

16. The method for independent communication control of claim 12, the method further comprises setting the send activation instruction to a send control area by the processor directly from a task.
